(19) United States
(12) Patent Application Publication
(10) Pub. No.: US 2022/0138814 A1
(43) Pub. Date: May 5, 2022

(54) SYSTEM AND METHOD FOR OUTSOURCED CONTENT MANAGEMENT ENABLING REASONABLE PAYMENT FOR PRODUCTION THEREOF

(71) Applicant: MELCHI CO., LTD., Seoul (KR)

(72) Inventor: Yang Woo NAM, Gwangju-si (KR)

(73) Assignee: MELCHI CO., LTD., Seoul (KR)

(21) Appl. No.: 17/423,124

(22) PCT Filed: Jan. 16, 2020
(86) PCT No.: PCT/KR2020/000775

§ 371 Date: Jul. 15, 2021

(30) Foreign Application Priority Data
Jan. 18, 2019 (KR) 10-2019-0006881

(51) Int. Cl. G06Q 30/02; G06Q 30/06; G06Q 10/08; G06Q 10/06

(52) U.S. Cl. CPC G06Q 30/0283; G06Q 10/0639; G06Q 10/087; G06Q 30/0641

(57) ABSTRACT

Systems and methods for outsourced content management enabling reasonable payment for the production thereof. A server for managing outsourced contents comprises: a content collecting unit which generates a group having a plurality of slots where contents can be uploaded, and uploads, to empty slots of the group, contents received from external production company devices; a storage unit; a content providing unit which provides the generated purchase page for user devices; a content result assessing unit which calculates results of each content falling into the group by tracking feedback from the user devices during a predetermined period since the launch of the contents on the purchase page; and a production payment managing unit which determines a total amount for producing all the contents falling into the group and determines respective dividends in the total amount for the production to be distributed among the production companies having provided the respective contents.

### TECHNICAL FIELD

The present invention relates to an outsourced contents service, and more particularly, to an outsourced content management system and method capable of paying a reasonable production price to outsourced production companies in consideration of contents quality.

### BACKGROUND ART

In the services that provide multimedia contents to users, there are many cases in which service providers provide outsourced contents delivered from external production companies, rather than contents produced by themselves. For example, when video templates collected through external production companies are uploaded to a purchase page or a template sharing page, users may easily create videos by selecting desired templates.

It is general that the same production price is paid in return for the contents provided by the external production companies. However, since quality of the outsourced contents vary depending on the skill of producers, the quality of contents even in the same category sold on the same page is not equal, and therefore, it is unfair to pay the same price without taking into account the quality of contents, and it adversely affects the quality of contents.

Accordingly, it is required to provide a technique capable of paying a reasonable production price for outsourced contents.

### DISCLOSURE OF INVENTION

### Technical Problem

Therefore, the present invention has been made in view of the above problems, and it is an object of the present invention to provide a system and method for managing outsourced contents, which can reasonably pay a production price according to the quality of the outsourced contents or a result of the outsourced in the market.

### Technical Solution

To accomplish the above object, an outsourced content management server according to an embodiment of the present invention may comprise: a content collecting unit for generating a group having a plurality of slots where contents can be uploaded, and uploading contents received from external production company devices to empty slots of the group; a storage unit for storing the received contents and information on the group; a content providing unit for generating a purchase page for contents belonging to the group, and providing the generated purchase page to a user device, when collection of contents is completed for the group; a content result assessing unit for calculating a result for the contents belonging to the group by tracking a response of the user device during a predetermined period after the contents are released through the purchase page; and a production payment managing unit for determining a total production price of all the contents belonging to the group, and determining amounts to be distributed to the production companies having provided the contents from the total production price according to the results of the contents assessed by the content result assessing unit.

The production payment managing unit may process the determined total production price as a deposit, and control to transfer the determined distribution amount to an account of each content production company.

The content collecting unit may set a content category input from a manager of the server to the group, and provide the production company devices with video template collection information including the set content category, the number of uploadable video templates for the group, an amount of the deposit corresponding to the total production price to be paid to the production companies for the group, and a deposit distribution rule.

The content providing unit may change a content arrangement order of the purchase page according to the results of the contents calculated by the content result assessing unit.

The content result assessing unit may calculate a result score of the contents in consideration of at least one factor among the number of purchases, the number of uses, the number of views, a sales volume, and a user preference score of the contents belonging to the group, and the production payment managing unit may determine a ratio for distributing the total production price for the contents according to the calculated result scores.

The content result assessing unit may compare content results calculated during a predetermined period after the contents are released through the purchase page with content results assessed after the distribution amounts are determined, estimate cheating of corresponding content production companies when there is a difference more than a predetermined threshold as a result of the comparison, and notify the cheating to the production company device or a manager of the server.

The content providing unit may randomly change an arrangement order of the contents belonging to the group on the purchase page every time a user connects.

According to an embodiment of the present invention, an outsourced content management method performed by an outsourced content management server that provides outsourced contents collected from production company devices to a user device may comprise: a content collecting step of generating a group having a plurality of slots where contents can be uploaded, and uploading contents received from external production company devices to empty slots of the group; a total production price determination step of calculating a total production price of all contents uploaded to the group; a content providing step of generating a purchase page for contents belonging to the group, and providing the generated purchase page to a user device, when collection of contents is completed for the group; a content result assessing step of calculating a result for the contents belonging to the group by tracking a response of the user device during a predetermined period after the contents are released through the purchase page; and a distribution step of determining amounts to be distributed to the production companies having provided the contents from the total production price according to the calculated results of the contents.

### Advantageous Effects

According to the present invention, instead of paying the same price for all outsourced contents, it is possible to reasonably calculate and pay a production price according to the quality or a result in the market.

According to the present invention, as a production price to be paid for outsourced contents is deposited to a trustworthy depository institution prior to collection of the contents or a payment guarantee is received from a specialized institution, content production companies may be guaranteed to receive a payment.

According to the present invention, as the contents production price is calculated according to the quality or result of multimedia contents, satisfaction of contents users can be maximized by naturally inducing improvement in quality of outsourced contents.

### BRIEF DESCRIPTION OF THE DRAWINGS

FIG. 1 is a view showing the network configuration of an outsourced content management system according to an embodiment of the present invention.

FIG. 2 is a block diagram showing the configuration of an outsourced content management server according to an embodiment of the present invention.

FIG. 3 is a flowchart illustrating an outsourced content management method according to an embodiment of the present invention.

FIG. 4 is a flowchart illustrating an outsourced content management method using a deposit system according to an embodiment of the present invention.

FIG. 5 is a view showing a group having a plurality of content slots according to an embodiment of the present invention.

### DESCRIPTION OF SYMBOLS

100: Outsourced content management server

110: Production company device

120: User device

130: Total production price

210: Control unit

211: Content collecting unit

212: Content providing unit

213: Content result assessing unit

214: Production payment managing unit

215: Content storage unit

220: Communication unit

230: Database

### BEST MODE FOR CARRYING OUT THE INVENTION

The terms used in this specification will be briefly described, and the present invention will be described in detail.

Although general terms widely used at present are selected as the terms used in this specification as much as possible considering the functions of the present invention, this may vary according to the intention of those skilled in the art, precedents, or emergence of new techniques. In addition, in specific cases, there are terms arbitrarily selected by the applicant, and in this case, the meaning of the terms will be described in detail in corresponding descriptions of the present invention. Therefore, the terms used in the present invention should be defined based on the meaning of the terms and the overall contents of the present invention, not by the simple names of the terms.

When a part “includes” a component throughout the specification, this means that other components may be further included, rather than excluding other components, unless otherwise stated. In addition, terms such as “ . . . means”, “ . . . unit”, and “module” described in the specification mean a unit that performs at least one function or operation, and they may be implemented in hardware, software, or a combination of hardware and software.

Hereinafter, embodiments of the present invention will be described in detail with reference to the accompanying drawings so that those skilled in the art may easily embody the present invention. However, the present invention may be embodied in several different forms and is not limited to the embodiments described herein. In addition, parts irrelevant to the description are omitted in the drawings in order to clearly explain the present invention, and similar reference numerals are attached to similar parts throughout the specification.

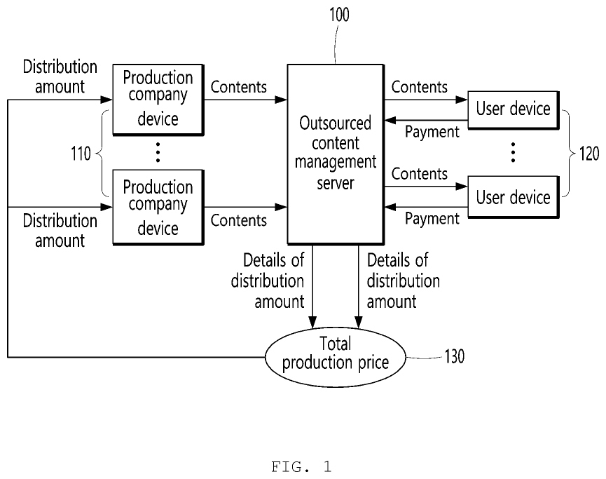

FIG. 1 is a view showing the network configuration of an outsourced content management system according to an embodiment of the present invention.

Referring to FIG. 1, an outsourced content management system includes a device 110 of a production company who produces and provides contents, an outsourced content management server 100 for mediating use or purchase of outsourced contents received from the production company device 110, and a device 120 of a user who connects to the server 100 and views or purchases desired contents.

The production company device 110 provides contents to the outsourced content management server 100. In the present invention, the contents are a target that is serviced to a user through the outsourced content management server 100, and may include various types of multimedia contents. For example, the contents may be completed contents such as video contents, photos, audio contents or the like, or a tool such as a video template, through which a user may easily produce his/her own videos by performing additional editing.

The producer of contents connects to the outsourced content management server 100 through the production company device 110 to confirm content collection information and uploads produced contents to the server 100 according thereto. In the present invention, the production company or the producer means a company or a person who has a right to sell, transfer, or rent the contents and may provide the contents to a company that operates the server 100, as well as a company or a person who has actually produced the contents.

The user device 120 outputs a content purchase page provided by the server 100, transmits data for purchasing contents selected according to input of a user, and transmits payment information to the server 100 in return for it.

The production company device 110 and the user device 120 are personal computers, notebook computers, cellular phones, personal digital assistants (PDAs), laptop computers, media players, or other mobile or non-mobile computing devices, and may include all kinds of devices capable of transmitting contents to the server 100 or receiving contents from the server 100 through a network and playing the contents.

The outsourced content management server 100 is a computing device for collecting contents from the production company device 110, providing content service to the user device 120 using the contents, determining a contents production price in advance, and reasonably distributing the price according to the result of the contents in the market, and the outsourced content management server 100 includes a hardware processor and memory, and installs and executes software for operating the outsourced contents.

The outsourced content management server 100 manages outsourced contents through a series of processes of collecting and selling contents in units of groups. The group includes slots for uploading a predetermined number of contents, and when collection of contents is completed and the slots are filled, a group of contents is completed and automatically released. At this point, it is preferable to configure similar or identical contents in one group. Therefore, the contents producer may easily grasp a category where the contents that he or she has produced belong to, and the outsourced content management server 100 may manage the contents with ease and maintain fairness of assessment by allowing result assessment for each group. As a result, fair assessment makes it possible to make a payment of a reasonable production price corresponding to the quality of the contents.

The outsourced content management server 100 determines the category of the group to be newly created, the number of slots, and the total production price according to input of a manager, and creates a group having a corresponding number of empty slots. At this point, the number of slots may be determined in proportion to the total production price.

The outsourced content management server 100 may notify the determined total production price to an external guarantee server (not shown) and receive confirmation of guaranteeing payment in response thereto. The external guarantee server is a server operated by an authorized payment guarantee professional organization and will have an address that is set according to a predetermined contract. As details of payment guarantee confirmation are included in the announcement related to collection of the outsourced contents, it is possible to provide content producers with confidence that the production price will be paid in the future without fail.

The outsourced content management server 100 may control to deposit an amount corresponding to the total production price. The deposit means to place money, securities, and other things in a deposit office or a depository institution for the purpose of repayment, collateral, storage, or the like. A specific method of the deposit may vary according to embodiments. Meanwhile, information on the deposit may be stored in the metadata of each group, and a content producer may confirm guarantee of payment according to production of contents through the metadata. In this way, production of high-quality contents may be induced as stability of payment of the production price is guaranteed through the deposit.

For example, the server 100 may store a document proving the deposit according to input of a manager who has deposited the money and notify the production company of the document through the production company device 110, or deposit a corresponding amount into a deposit account of a depository institution and notify a deposit completion certificate to the production company through the production company device 110, or a separate deposit management server (not shown) may be provided.

The deposit management server may be implemented as a computing device that receives a message instructing deposit of a production price from the outsourced content management server 100 and carries out the deposit before the contents are released, and sends a distribution amount to each production company according thereto when details of the distribution amount are received from the server 100 after the contents are released.

The outsourced content management server 100 receives contents for filling the newly created group from the production company device 110 and uploads the contents to the empty slots. When collection of contents is completed for the group, a purchase page for these contents is generated and provided to the user device 120. When purchase and payment information on certain contents is received from the user device 120, the server 100 allows the user device 120 to view or download the contents.

The outsourced content management server 100 sets a predetermined period after the contents are exposed to the market as a result assessing period, tracks users' response through the user device 120 during the period, and calculates a result according thereto. At this point, accuracy of assessment is required since result assessment is directly related to payment of a production price, and accordingly, it is desirable to include a process of estimating cheating of a corresponding content production company. That is, a distribution amount may be determined in response to estimation of cheating in order to pay a reasonable content production price. Meanwhile, estimation of cheating may be continuously performed during purchase of contents, as well as during the result assessing period.

The outsourced content management server 100 determines amounts to be distributed for the contents according to result scores calculated during the result assessing period, and controls to pay a corresponding amount to each content production company from the money deposited in advance.

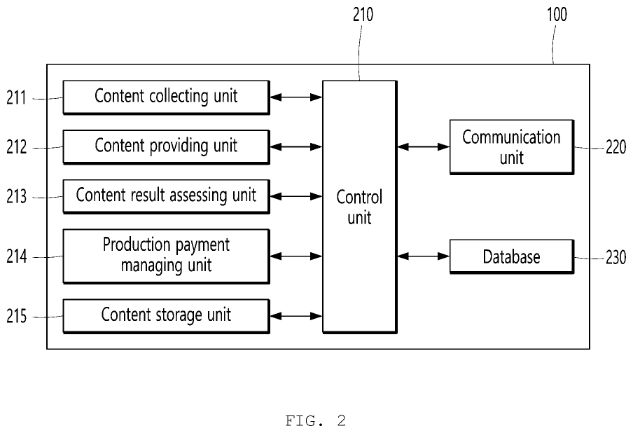

FIG. 2 is a block diagram showing the configuration of an outsourced content management server according to an embodiment of the present invention.

Referring to FIG. 2, the outsourced content management server 100 may include a control unit 210, a content collecting unit 211, a content providing unit 212, a content result assessing unit 213, a production payment managing unit 214, a content storage unit 215, a communication unit 220, and a database 230.

The control unit 210 controls the content collecting unit 211, the content providing unit 212, the content result assessing unit 213, the production payment managing unit 214, the content storage unit 215, the communication unit 220, and the database 230 so that the outsourced content management server 100 may collect contents from the production company device 110, provide the contents to the user device 120, determine a contents production price in advance, and reasonably distribute money according to the result of the contents in the market.

The content collecting unit 211 generates a group having a plurality of slots for uploading contents, and uploads the contents received from the external production company device 110 to empty slots of the group.

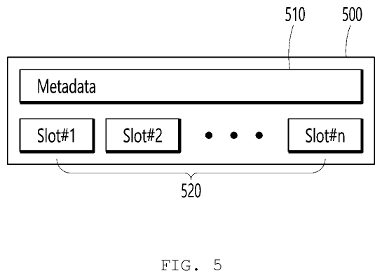

FIG. 5 is a view showing a group having a plurality of content slots according to an embodiment of the present invention.

Referring to FIG. 5, a group 500 may include a plurality of slots 520, which are virtual spaces that can contain content groups of the same category, and content categories, a maximum number of contents, a total production price to be paid for production of all included contents, information on the rule of distributing and paying the production price for the contents, and the like may be associated and stored as metadata 510.

The content collecting unit 211 may set a content category input from the manager of the server 100 to a corresponding group, and provide the production company device 110 with content collection information including the content category, the number of uploadable contents (e.g., video templates) for the group, a total production price to be paid to production companies, and a distribution rule.

The content collection information may be transferred to the production company device 110 in various forms such as a homepage, a text message, a multimedia message, or a notification message through an application dedicated to a production company. In addition, the content collection information may include link information for directly moving to a screen capable of uploading contents to an empty slot of a corresponding group.

The production payment managing unit 214 determines and distributes a total production price of all contents belonging to the group. When the total production price is processed as a deposit, it is controlled to transfer an amount corresponding to the total production price to a predetermined deposit institution. The total production price may be input by the manager of the server 100, read from the metadata of the group, or automatically calculated in consideration of the number of contents belonging to the group.

The content storage unit 215 stores the contents received from the production company device 110 and information on the corresponding group. The content storage unit 215 may store the contents and/or information on the group in the database 230 described below.

When collection of contents is completed for a predetermined group, the content providing unit 212 generates a purchase page for the contents belonging to the corresponding group and provides the purchase page to the user device 120. A user may view the purchase page through a dedicated application installed in the user device 120 or a homepage and select desired contents from the purchase page, and perform various responses such as inquiry, purchase, writing a review, input of a preference score, and the like.

The content result assessing unit 213 sets a predetermined period after the contents are released as a quality assessment period through the purchase page, tracks the response from the user device 120 during the set quality assessment period, and calculates a result for the contents belonging to the group.

The content result assessing unit 213 may calculate a result score of the contents in consideration of at least one factor among the number of purchases, the number of uses, the number of views, the sales volume, the number of reviews, the number of interested users, and the user preference score of the contents belonging to the group. The factors are basic information used for calculation of the result scores.

The metadata of the group may include information on target customers of the collected contents. For example, target customers of the contents to be collected, such as female/housewives, female/teenagers/middle school students, male/forties/office workers, and the like may be included as a meta tag.

Information on the target customers may be additionally used by the content result assessing unit 213 to calculate result scores. After calculating the result scores using the sales volume of the contents, the number of inquiring or using the contents and the like as basic information, different weighting values may be applied according to the frequency of the total sales volume or the number of inquiring or using the contents matching the target customer information. Among the contents recording the same sales volume, contents with high loyalty of target customers are determined as having a relatively high quality, and a relatively high weighting value is applied as a reward for the high quality to increase the proportion to be distributed among the total production price. Accordingly, reasonable compensation is possible for the contents strategically well-produced to make target marketing easier.

Assessment of results for the contents may be continued even after the quality assessment period, and this may be performed as part of ensuring fairness in quality assessment. The content result assessing unit 213 may compare the content results calculated during the quality assessment period with the content results assessed after the distribution amounts are determined, estimate cheating of corresponding content production companies when there is a difference more than a predetermined threshold as a result of the comparison, and notify the cheating to the production company device 110 or the manager of the server 100.

The content providing unit 212 may change the content arrangement order of the purchase page according to the results of the contents calculated by the content result assessing unit 213. For example, the contents may be arranged in a descending order of the number of inquiries by periodically comparing the number of inquiries on the contents.

The content providing unit 212 may randomly change the arrangement order of the contents belonging to each group in the purchase page every time the user connects. Since the contents exposed at the front or on the top of the purchase page may be advantageous for sales when several contents are released to be included in one group, fairness can be ensured by returning an order every time the user connects. In this way, more accurate result assessment can be made by combining estimation of cheating while fairness is ensured, and this enables payment of a reasonable production price.

The production payment managing unit 214 determines the amounts to be distributed to the production companies who have provided the contents from the total production price determined in advance before the contents are released according to the results for the contents assessed by the content result assessing unit 213. The production payment managing unit 214 may determine a ratio for distributing the production price for the contents according to the result scores calculated by the content result assessing unit 213, and determine an amount for the contents according thereto.

The database 230 stores the contents collected by the server 100 from the production company device 110, and stores various information needed to pay a reasonable price for the contents.

The communication unit 220 includes a network module for the server 100 to provide the contents collected from the production company device 110 to the user device 120, and transmit and receive various information needed to pay a reasonable price for the contents to and from the external devices 110 and 120.

In the case where service target contents are a video template, the outsourced content management server 100 may provide the user device 120 with an editing tool for editing the video template to create video contents desired by the user.

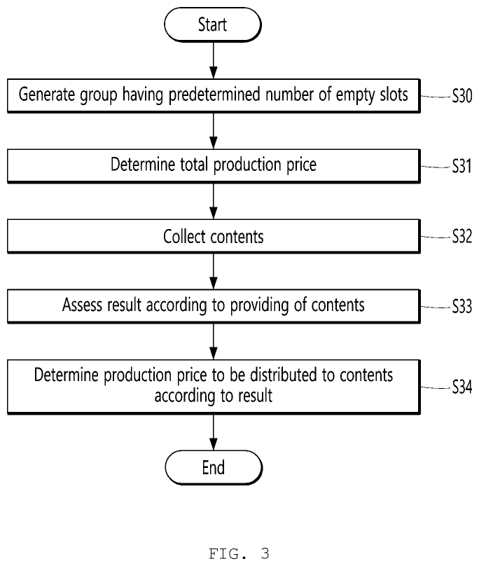

FIG. 3 is a flowchart illustrating an outsourced content management method performed by the outsourced content management server 100 that provides outsourced contents collected from the production company device 110 to the user device 120 according to an embodiment of the present invention.

At step S30, the server 100 generates a group having a predetermined number of slots where contents may be uploaded. The contents included in the group may be included in the same purchase page and provided to the user, and the number of slots may be determined by a manager in consideration of the configuration of the purchase page.

Step S31 is a step of calculating and determining the total production price of all contents uploaded to the group. For example, when a content set in the category of ‘animal picture’ is to be released, first, the number of contents is determined to generate a group having as many empty slots as the number of contents, and an amount to be paid for all the contents is determined in advance and announced. At this point, it is possible to receive a confirmation that guarantees payment from an external guarantee server and to include details thereof in the announcement.

Step S32 is a content collecting step of uploading the contents received from the external production company device 110 to the empty slots of the group generated in a corresponding category. The empty slots may be sequentially filled with the contents received from the production company device 110.

At step S33, a purchase page of the contents belonging to the group is generated and provided to the user device 120, and a result for the contents is assessed by tracking the response from the user device during a predetermined period after the contents are released through the purchase page.

At step S34, the amounts to be distributed to the production companies who have provided the contents are determined from the total production price according to the calculated results for the contents. The criteria for assessing the results and determining the distribution amounts may be set in advance by the manager of the server 100.

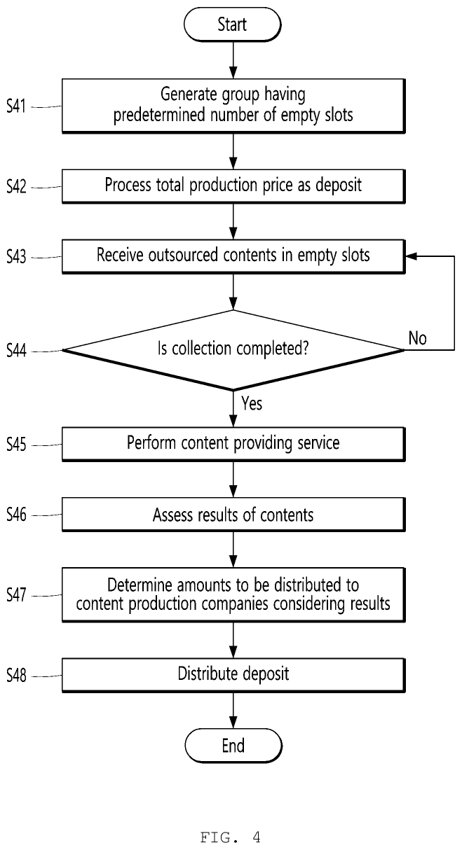

FIG. 4 is a flowchart illustrating an outsourced content management method using a deposit system according to an embodiment of the present invention.

At step S41, the server 100 generates a group having a plurality of slots for uploading contents.

Step S42 is a deposit step of calculating a total production price of all contents uploaded to the group and processing the total production price as a deposit.

For example, when a video template set in the category of ‘childcare’ is to be released, first, the number of contents is determined to generate a group having as many empty slots as the number of contents, and it is controlled to deposit an amount to be paid for all the contents before the contents are released.

Step S43 is a content collecting step of uploading the contents received from the external production company device 110 to the empty slots of the group generated in a corresponding category.

At the content collecting step, a content collecting page may be provided to the production company device 110 to receive an application for uploading contents to a collection target group, and a predetermined number of contents may be uploaded on the first-come first-served basis. The empty slots of the group will be occupied in order by the contents received from the production company device 110.

When the contents are uploaded, information on the contents such as a title, a producer, a size, a resolution, a subject and the like may also be received and stored as metadata of the contents.

The server 100 may manage content collection status for the group to control the content collecting page to be exposed until the collection is completed. The time of completing collection of contents may be set to a time of expiring a predetermined time period or a time of uploading contents to all the slots of the group.

Step S44 is a step of determining whether collection of contents is completed, and when collection of contents is completed, the process proceeds to step S35, and when collection of contents is not completed yet, the process returns to step S33.

Step S45 is a content providing step of generating a purchase page of the contents belonging to the group and providing the purchase page to the user device 120. When collection of contents is completed for the group, the server 100 may generate a purchase page for the contents by using the contents uploaded to the slots of the group and metadata including information on the contents. The user may view the purchase page through a dedicated application of the user device 120 or a predetermined homepage. When the automatically generated purchase page is exposed to users, the contents of the group are automatically released in the market.

Step S46 is a content result assessing step of calculating a result for the contents belonging to the group by tracking responses from user devices during a predetermined period after the contents are released through the purchase page. Assessing a result by examining responses of consumers for a predetermined period is to calculate a price to be differently paid instead of paying the same price for the contents.

At step S47, according to the results for the contents calculated as described above, the amounts to be distributed to the production companies who have provided the contents are determined from the money deposited in advance, and at step S48, a portion of the deposit is distributed to each content production company according to the determined amount. The criteria for assessing the results and determining the distribution amounts may be set in advance by the manager of the server 100. The server 100 may control to send the amount to be distributed to a preset account of each production company.

For example, it may be set to calculate a result score based on the sales volume and distribute the money in proportion to the score, or set to calculate a result score for the contents by reflecting the sales volume as much as 70% and the number of users who have clicked ‘Like’ as much as 30% and distribute the money in proportion to the score.

Even after distribution of the deposit, the contents of the group may be exposed and sold to users, and results may be calculated thereafter by continuously tracking responses of users on the contents.

The results assessed after automatic distribution may be used to determine the arrangement order of the contents belonging to the corresponding group. For example, the server 100 updates the purchase page at predetermined intervals, and may dynamically configure the purchase page in a way of exposing contents of high sales volume at the top of the purchase page or adjusting a product image size to be larger.

The results assessed after automatic distribution may also be used to detect cheating of content production companies. When the difference between the result score calculated before automatic distribution of deposit and the result score calculated after automatic distribution is more than a predetermined threshold, it may be presumed that the production company of the corresponding contents has clicked fraudulently to receive a higher production unit price.

A production company suspected of fraudulent clicks is separately monitored when outsourced contents are collected later to enable fair and reasonable management of outsourced contents. Prevention of fraudulent clicks, i.e., abusing, by production companies or related parties can be an important issue in the management of outsourced contents.

For effective prevention of abusing, as described above, a method of randomly determining a period for assessing results after release of contents may be used instead of assessing the results starting from immediately after the contents are released until a predetermined period is elapsed and using the results as a basis of automatic distribution.

For example, instead of assessing a result for a week immediately after the contents are released and adjusting the production price according thereto, the result assessing period is randomly determined in a way such as some hours on weekdays, some hours on weekends, and/or some hours on specific days of a week in a period of two weeks after the contents are released. According to this method, although a production company gathers acquaintances or related persons immediately after the release to click fraudulently, it is possible to prevent great impact on the result score.

As another example, when specific contents are purchased or used several times using a single user ID or through the same user device, it may be counted only once when results are assessed.

The method according to an embodiment of the present invention may be implemented in the form of program instructions that can be executed through various computer means and recorded in a computer-readable medium. The computer-readable medium may include program instructions, data files, data structures and the like alone or in combination. The program instructions recorded on the medium may be specially designed and configured for the present invention, or may be known to and used by those skilled in computer software. Examples of the computer-readable recording medium include magnetic media such as hard disks, floppy disks and magnetic tapes, optical media such as CD-ROMs and DVDs, magneto-optical media such as floptical disks, and hardware devices specially configured to store and execute the program instructions such as ROM, RAM, flash memory and the like. Examples of the program instructions include high-level language codes that can be executed by a computer using an interpreter or the like, as well as machine language codes produced by a compiler.

Although the embodiments of the present invention have been described above in detail, the scope of the present invention is not limited thereto, and various modified and improved forms of those skilled in the art using the basic concept of the present invention as defined in the following claims also belong to the scope of the present invention.

1. An outsourced content management server comprising:
a content collecting unit for generating a group having a plurality of slots where contents can be uploaded, and uploading contents received from external production company devices to empty slots of the group;
a storage unit for storing the received contents and information on the group;
a content providing unit for generating a purchase page for contents belonging to the group, and providing the generated purchase page to a user device, when collection of contents is completed for the group;
a content result assessing unit for calculating a result for the contents belonging to the group by tracking a response of the user device during a predetermined period after the contents are released through the purchase page; and
a production payment managing unit for determining a total production price of all the contents belonging to the group, and determining amounts to be distributed to the production companies having provided the contents from the total production price according to the results of the contents assessed by the content result assessing unit.

2. The server according to claim 1, wherein the production payment managing unit processes the determined total production price as a deposit, and controls to transfer the determined distribution amount to an account of each content production company.

3. The server according to claim 2, wherein the content collecting unit sets a content category input from a manager of the server to the group, and provides the production company devices with video template collection information including the set content category, the number of uploadable video templates for the group, an amount of the deposit corresponding to the total production price to be paid to the production companies for the group, and a deposit distribution rule.

4. The server according to claim 1, wherein the content providing unit changes a content arrangement order of the purchase page according to the results of the contents calculated by the content result assessing unit.

5. The server according to claim 1, wherein the content result assessing unit calculates a result score of the contents in consideration of at least one factor among the number of purchases, the number of uses, the number of views, a sales volume, and a user preference score of the contents belonging to the group, and the production payment managing unit determines a ratio for distributing the total production price for the contents according to the calculated result scores.

6. The server according to claim 1, wherein the content result assessing unit compares content results calculated during a predetermined period after the contents are released through the purchase page with content results assessed after the distribution amounts are determined, estimates cheating of corresponding content production companies when there is a difference more than a predetermined threshold as a result of the comparison, and notifies the cheating to the production company device or a manager of the server.

7. The server according to claim 1, wherein the content providing unit randomly changes an arrangement order of the contents belonging to the group on the purchase page every time a user connects.

8. An outsourced content management method performed by an outsourced content management server that provides outsourced contents collected from production company devices to a user device, the method comprising:
a content collecting step of generating a group having a plurality of slots where contents can be uploaded, and uploading contents received from external production company devices to empty slots of the group;
a total production price determination step of calculating a total production price of all contents uploaded to the group;
a content providing step of generating a purchase page for contents belonging to the group, and providing the generated purchase page to the user device, when collection of contents is completed for the group;
a content result assessing step of calculating a result for the contents belonging to the group by tracking a response of the user device during a predetermined period after the contents are released through the purchase page; and
a distribution step of determining amounts to be distributed to the production companies having provided the contents from the total production price according to the calculated results of the contents.

9. The method according to claim 8, wherein the total production price determination step includes the step of processing the determined total production price as a deposit, and the distribution step includes the step of controlling to transfer the determined distribution amount to an account of each content production company.

10. The method according to claim 9, wherein the content collecting step includes the step of setting a content category input from a manager of the server to the group, and providing the production company devices with video template collection information including the set content category, the number of uploadable video templates for the group, an amount of the deposit corresponding to the total production price to be paid to the production companies for the group, and a deposit distribution rule.

11. The method according to claim 8, wherein the content providing step includes the step of changing a content arrangement order of the purchase page according to the results of the contents calculated by the content result assessing unit.

12. The method according to claim 8, wherein the content result assessing step includes the step of calculating a result score of the contents in consideration of at least one factor among the number of purchases, the number of uses, the number of views, a sales volume, and a user preference score of the contents belonging to the group.

13. The method according to claim 8, further comprising the steps of:
comparing content results calculated during a predetermined period after the contents are released through the purchase page with content results assessed after the distribution amounts are determined; and
estimating cheating of corresponding content production companies when there is a difference more than a predetermined threshold as a result of the comparison, and notifying the cheating to the production company device or a manager of the server.

14. The method according to claim 8, wherein the content providing step includes the step of randomly changing an arrangement order of the contents belonging to the group on the purchase page every time a user connects.
